(19) United States
(12) Patent Application Publication
(10) Pub. No.: US 2015/0288216 A1
(43) Pub. Date: Oct. 8, 2015

(54) REMOTE WIRELESS CHARGING SYSTEM

(71) Applicant: Che-Min Wu, Torrance, CA (US)

(72) Inventor: Che-Min Wu, Torrance, CA (US)

(21) Appl. No.: 14/679,946

(22) Filed: Apr. 6, 2015

Related U.S. Application Data
(60) Provisional application No. 61/975,761, filed on Apr. 5, 2014.
(60) Provisional application No. 62/029,904, filed on Jul. 28, 2014.

(51) Int. Cl. H02J 7/02; H02J 7/00

(52) U.S. Cl. CPC H02J 7/025; H02J 7/0044

(57) ABSTRACT

A remote wireless charging device may include a power source, an antenna, a wireless charging transmitter to receive electrical power from the power source, and a power control circuit to manage usage of the battery. In one embodiment, the wireless charging transmitter receives the input energy from the power source and generates the radiated energy field, which is sent out through the antenna. A receiver of a mobile device, separated from the transmitter within a predetermined distance, is configured to receive and generate an output power for the mobile device. It is noted that a mutual resonant frequency exists between the transmitter and the mobile device, and the energy loss during the energy transmission can be minimized when the transmitter and the receiver both reach the mutual resonant frequency.

### CROSS-REFERENCE TO RELATED APPLICATIONS

This application claims priority under 35 U.S.C. §119 (e) to U.S. Provisional Patent Application Ser. No. 61/975,761, filed on Apr. 5, 2014, and Ser. No. 62/029,904, filed on Jul. 28, 2014, the entire contents of which are hereby incorporated by reference.

### FIELD OF THE INVENTION

The present invention generally relates to a wireless power charging platform, and more particularly to a portable system or device for remote wireless charging to mobile electronic devices.

### BACKGROUND OF THE INVENTION

Mobile phones are used for a variety of purposes, including keeping in touch with family members, conducting business, and having access to a telephone in the event of an emergency. Some people carry more than one cell phone for different purposes, such as for business and personal use. More recently, smartphones emerged to quickly replace traditional mobile phones. Simply speaking, smartphones are mobile phones equipped with more advanced computing capability and connectivity to perform much more tasks than basic mobile phones. More particularly, smartphones typically combine the features of a mobile phone with some other popular consumer devices, such as a personal digital assistant (PDA), a media player, a digital camera, or a GPS navigation unit. Modem smartphones may include more features including a touchscreen computer, a web browser and a plurality of application software (“Apps”).

One of the most important concerns of smartphone users is the battery life. As stated above, modern smartphones can perform just like a mini computer, however, unlike computers that may be used with the power cords for most of the time, smartphone users usually carry the phones with them and the battery inside the phone may be a sole power source thereof. Therefore, it may be inconvenient for the users if the battery cannot last long enough and the smartphone may lose the portability if the user has to charge it often.

To solve the battery issues in smartphones and other mobile devices such as tablets, currently people take power banks with them to prevent the mobile devices from running out of battery. A USB cable is usually needed to charge the mobile device, so if the user forgets to bring the USB cable with him/her, the mobile device cannot be charged. Although some manufactures make power banks with USB cables irremovable therefrom, the aesthetics value of the power bank may be sacrificed, as well as the integrity and rigidness thereof.

Thus, the demands for portable wireless chargers have increased rapidly because mobile devices including smartphones and tablets have become an indispensable portion in our daily lives. In general, a portable wireless charger is a combination of a rechargeable battery and a wireless charging system. However, current portable wireless chargers may be disadvantageous because most of them are bulky, not suitable for carrying around, and the capacity of the internal batteries is usually low due to volume/size limitation. Moreover, current portable wireless chargers have large energy loss, which accounts for heat dissipation and rise in temperature during the wireless power transmission. In other words, low battery capacities together with large energy waste would usually drain the battery fast. Thus, the charging capabilities of current portable wireless chargers are limited to providing only one or two charge circles to a mobile device.

In addition, current portable wireless chargers do not have significant increment in charging speed, which is slower or equivalent to traditional USB cable charging. Moreover, regular wireless charging uses electro-magnetic induction that requires very close-range contact and accurate alignment, and such requirements are not easy to fulfill and maintain in an outdoor occasion.

Conventional remote charging may include a high power transmitter broadcasting a certain pattern of waves in the space along certain directions, which may cause both energy wasting and human health issues under the radiation. For example, as shown in FIG. 1, U.S. Patent Publication No.: 2014/0375261 (“the '261 patent”) discloses a charging device that includes a transmitter unit associated with an antenna unit comprising a power antenna configured to define at least one charging zone for transmitting charging power to the at least one charging zone; a receiver for receiving signals from consumers located within the charging zone; and a controller unit. The controller is configured and operable to be responsive to a request signal from a consumer indicative of demand for charging, to initiate a charging process of the consumer by radiation from the power antenna toward said consumer to supply power required for operating a functional unit of said consumer. The power antenna may comprise an array of directional antenna elements, each defining the charging zone within a different angular segment of entire charging space defined by a radiation pattern of the antenna array.

Therefore, there remains a need for a new and improved omnidirectional wireless charging system to overcome the problems presented above.

### SUMMARY OF THE INVENTION

It is an object of the present invention to provide a remote wireless charging system that is omnidirectional, compact, lightweight, and has a high capacity battery.

It is another object of the present invention to provide a remote wireless charging system that has a controller modulus including a power control circuit and a wireless charging transmitter to significantly increase the charging speed comparing with regular USB cable charging and traditional wireless charging.

It is a further object of the present invention to provide a remote wireless charging system to simultaneously charge multiple devices and increase the distance of between the wireless charging system and the devices through a wireless antenna with a predetermined frequency and shape.

It is still a further object of the present invention to provide a remote wireless charging system having a controller modulus and fuel cell to reduce energy loss to a very low level.

In one aspect, a remote wireless charging device may include a wireless charging surface; a main case, a battery level indicator, and one or more USB ports. When in use, the user can simply dispose a mobile device, such as a cell phone with a receiver near the remote wireless charging device, and the charging process will begin within a few seconds. It is noted that the remote wireless portable charging device is not connected or plugged into any power supply on the wall when charging the mobile device.

In one embodiment, the remote wireless charging device may include an upper cover, a wireless charging antenna, a wireless charging transmitter, and a power control circuit. The upper cover is located underneath the wireless charging surface and is used to cover every component inside the main case. The wireless charging antenna is connected to the wireless charging transmitter and configured to emit electromagnetic pulses to realize the wireless charging, while the wireless charging transmitter is configured to transmit the electrical power to the antenna. The remote wireless charging device further includes a battery, which can be, but not limited to a regularly 3.7V Li-ion rechargeable battery. The power control circuit may include a battery charging port for charging the battery from external power sources.

It is noted that the remote wireless charging device includes a refillable fuel cell to significantly increase the capacity of the battery. In one embodiment, the fuel cell is a direct methanol fuel cell (DMFC), which can store high energy content in a small space and can produce a small amount of power over a long period of time.

The power control circuit is coupled to the power source including the fuel cell and battery. The power control circuit is configured to direct electrical power from the power source to the wireless charging transmitter, which transfers the electrical power to the wireless charging antenna and send it out to external receiving devices. The power control circuit can also detect the existence of external receiving devices and if the power control unit detects at least one external receiving device within a predetermined distance, the wireless charging process will be initiated and the electrical power will be transferred from the power source to the wireless charging transmitter.

The wireless charging transmitter is configured to receive the input energy from the power source 400 and generate the radiated energy field, which is sent out through the wireless charging antenna. A receiver of the mobile device, separated from the transmitter within a predetermined distance, is configured to receive and generate an output power for the mobile device. It is noted that a mutual resonant frequency exists between the transmitter and the mobile device, and the energy loss during the energy transmission can be minimized when the transmitter and the receiver both reach the mutual resonant frequency.

### BRIEF DESCRIPTION OF THE DRAWINGS

FIG. 1 illustrates a prior art disclosing a conventional wireless charging system.

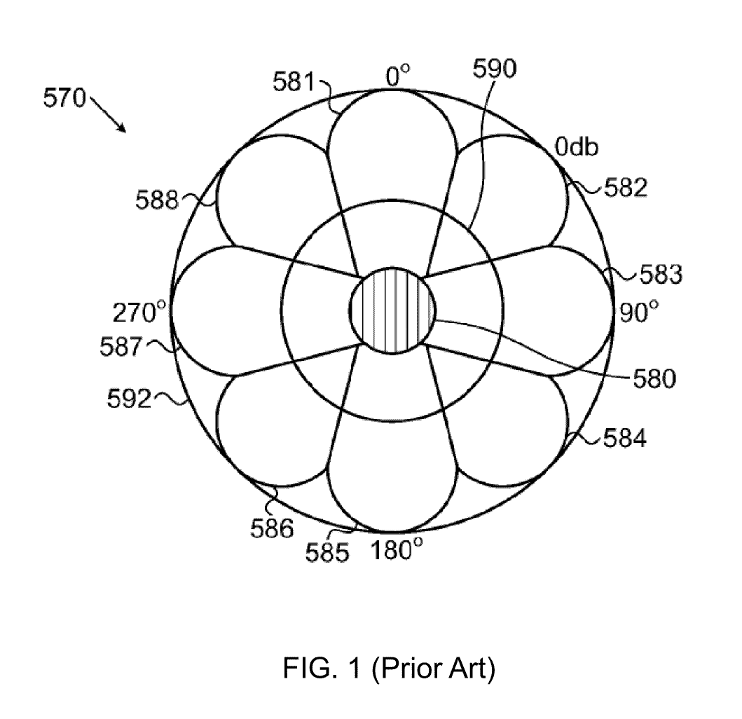

FIG. 2 illustrates an exploded view of a remote wireless charging device in the present invention.

FIG. 3 is a schematic view of a remote wireless charging system in the present invention.

FIG. 3a is a schematic view showing a radiated energy field of the remote wireless charging system in the present invention.

FIG. 3b is a schematic view showing a radiated energy field the remote wireless charging system in the present invention when the transmitter and the receiver are not well-aligned.

FIG. 4 illustrates the remote wireless charging system implemented in a vehicle, wherein the system remotely charges three mobile devices within the vehicle, while the mobile devices are in people's hand or being used.

FIG. 5 illustrates a block diagram of remote wireless charging in the present invention.

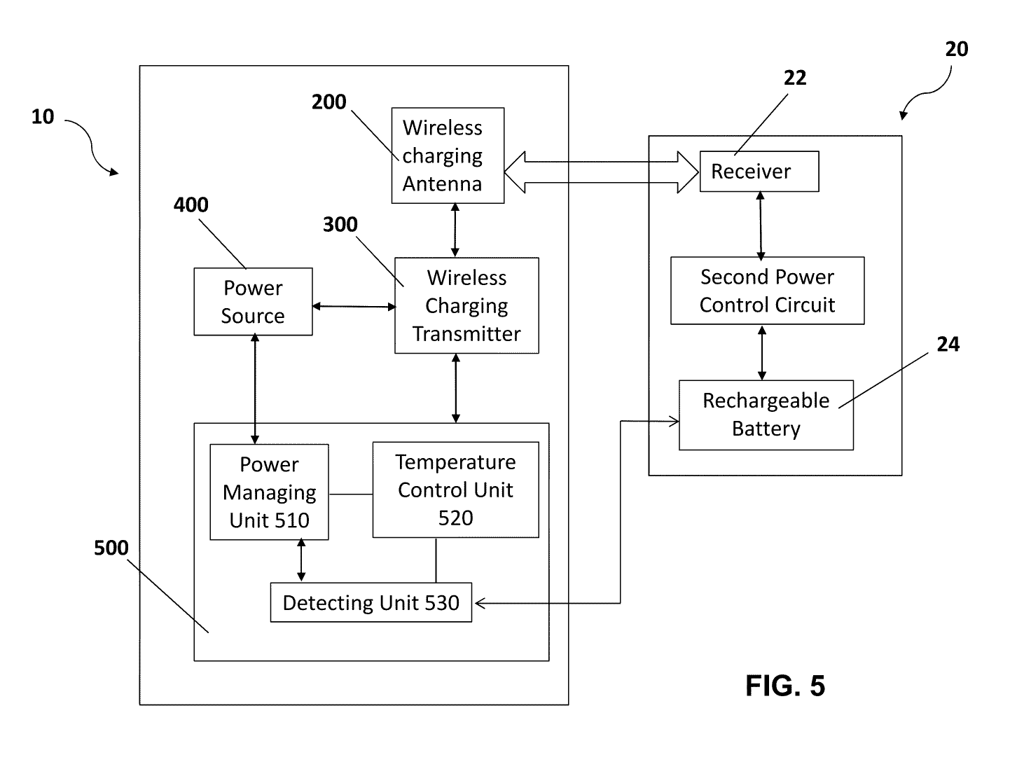

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

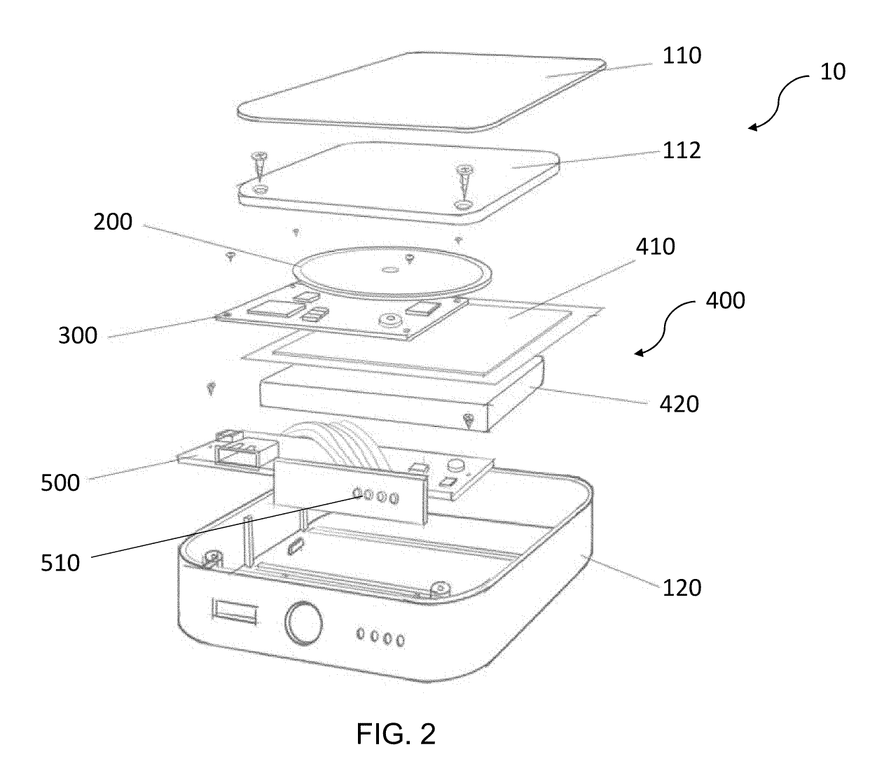

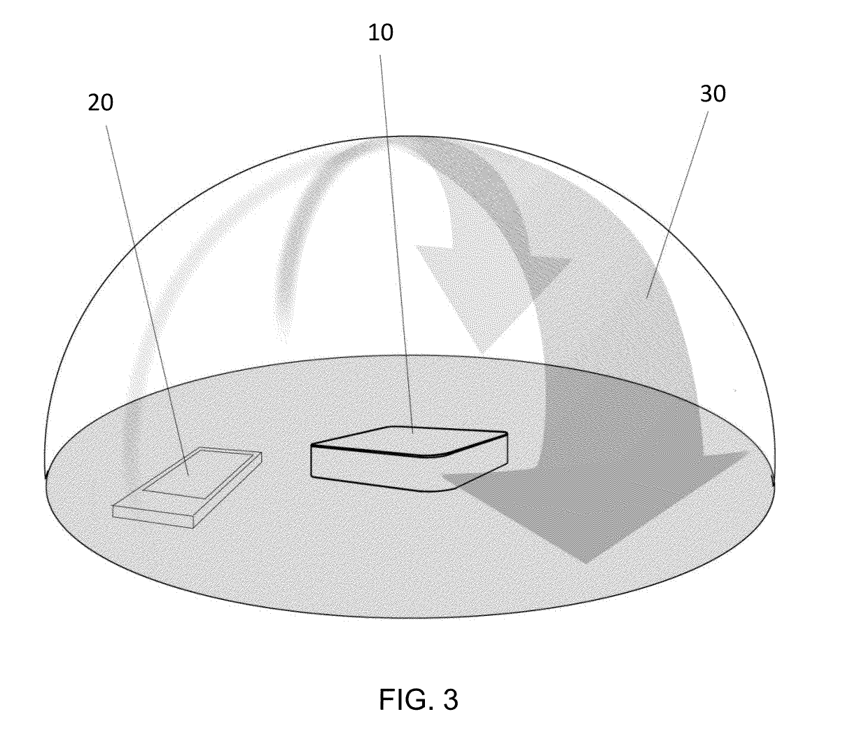

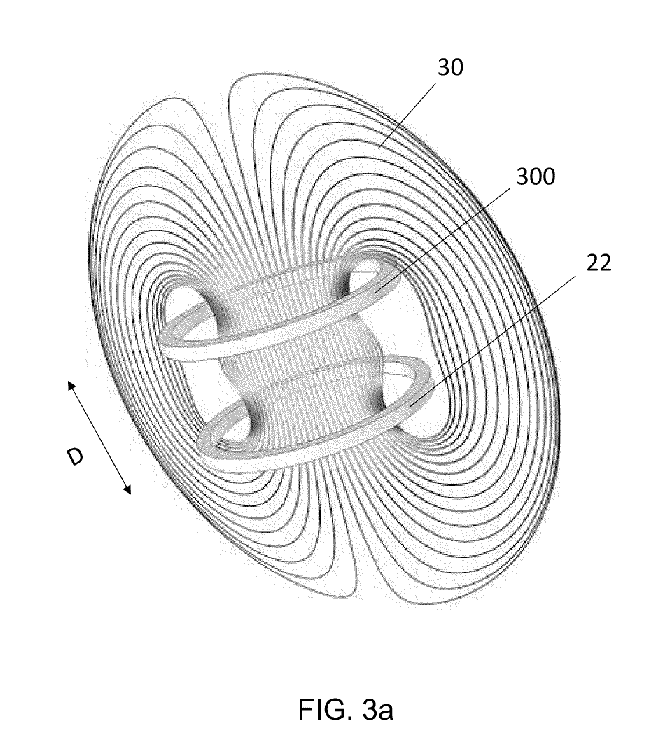

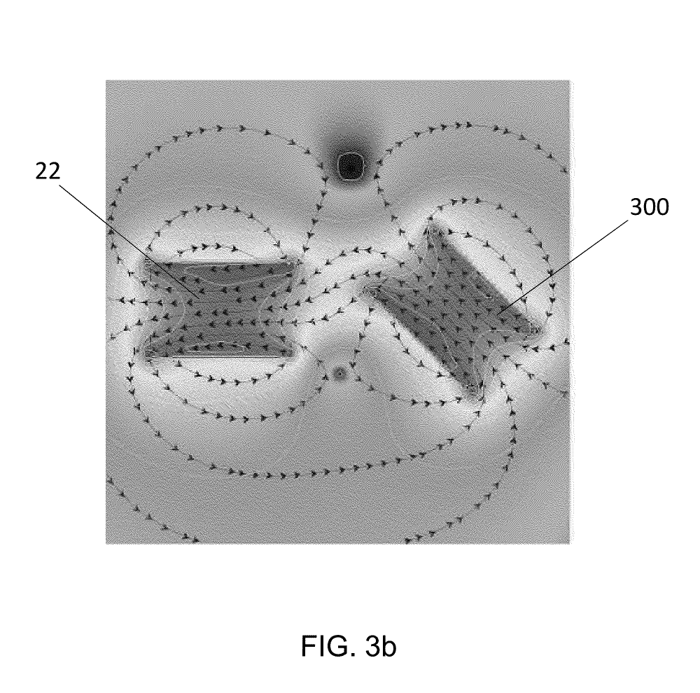

In one aspect, as shown in FIGS. 2 and 3, a remote wireless charging device 10 may include a wireless charging surface 110; a main case 120, a battery level indicator 510, and one or more USB ports. When in use, the user can simply dispose a mobile device 20, such as a cell phone with a receiver near the remote wireless charging device 10, and the charging process will begin within a few seconds. It is noted that the remote wireless portable charging device 10 is not connected or plugged into any power supply on the wall when charging the mobile device 20.

Referring to FIG. 2, the remote wireless charging device 10 may include an upper cover 112, a wireless charging antenna 200, a wireless charging transmitter 300, and a power control circuit 500. The upper cover 112 is located underneath the wireless charging surface 110 and is used to cover every component inside the main case 120. The wireless charging antenna 200 is connected to the wireless charging transmitter and configured to emit electromagnetic pulses to realize the wireless charging, while the wireless charging transmitter 300 is configured to transmit the electrical power to the antenna 200. The remote wireless charging device 10 further includes a power source 400, which may include a refillable fuel cell 410 and a battery 420, In one embodiment, the battery 420 can be, but not limited to a regularly 3.7V Li-ion rechargeable battery. The power control circuit 500 may include a battery charging port for charging the battery 500 from external power sources.

It is noted that the refillable fuel cell 400 is used to significantly increase the capacity of the battery 500. In one embodiment, the fuel cell 400 is a direct methanol fuel cell (DMFC), which can still store high energy content in a small space and can produce a small amount of power over a long period of time. It is believed that the DMFC's energy content is more than three times comparing with a Li-poly battery of same size.

The power control circuit 500 is coupled to the power source 400 including the fuel cell 410 and battery 420. The power control circuit 500 is configured to direct electrical power from the power source to the wireless charging transmitter 300, which transfers the electrical power to the wireless charging antenna 200 and send it out to external receiving devices. The power control circuit 500 can also detect the existence of external receiving devices and if the power control unit 500 detects at least one external receiving device within a predetermined distance, the wireless charging process will be initiated and the electrical power will be transferred from the power source to the wireless charging transmitter 300.

Furthermore, the antenna 200, the wireless charging transmitter 300 and the power control circuit 500 are configured to determine whether the external receiving device is fully charged or not. If the external receiving device is fully charged, the power control circuit 500 will stop the wireless charging process to save energy. If a non-aligned signal from the external receiving device is detected by the wireless charging transmitter 300, the wireless charging transmitter 300 will send out a signal to the power control circuit 500 not to initiate the charging process.

FIG. 3 illustrates a schematic view of the remote wireless charging system in the present invention. The mobile device 20 is disposed in a radiated energy field 30 generated by the wireless charging device 10. Since the mobile device 20 is placed within the field, or within an effective charging range of the wireless charging device 10, the mobile device 20 is being charged wirelessly and remotely by the wireless charging device 10.

More specifically, as shown in FIGS. 3a and 6, the wireless charging transmitter 300 receives the input energy from the power source 400 and generates the radiated energy field 30, which is sent out through the wireless charging antenna 200. A receiver 22 of the mobile device 20, separated from the transmitter 300 within a predetermined distance D, is configured to receive and generate an output power for the mobile device 20. It is noted that a mutual resonant frequency exists between the transmitter 300 and the mobile device 20, and the energy loss during the energy transmission can be minimized when the transmitter 300 and the receiver 22 both reach the mutual resonant frequency. It is noted that the transmitter 300 and receiver 22 are well-aligned, so the energy loss can also be reduced.

During conventional remote wireless charging process, the transmitter and receiver have to be aligned or they have to be specially arranged to generate a maximum energy transmission, which causes certain inconvenience for the users whose mobile device may need to be charged when in use. As shown in FIG. 3b, when the transmitter 300 and receiver 22 are not well-aligned, the energy transmission can also be conducted in the present invention through an adjustment of the shape of the antenna (not shown) and the resonant frequencies of the transmitter 300 and the receiver 22. In other words, the present invention provides an omnidirectional wireless charging device. Namely, the user does not have to align the mobile device to the remote wireless charger and the mobile device can be remotely and wirelessly charged in any orientation.

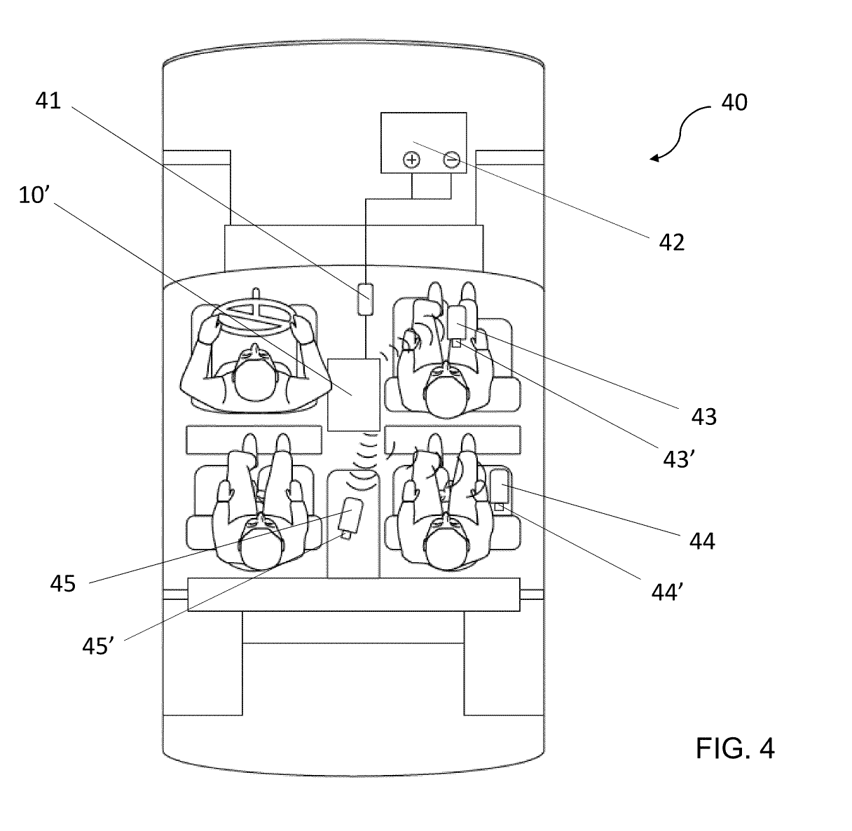

In addition to remotely and wirelessly charging in any orientation, the wireless charging device 10 is configured to charge multiple mobile devices. Referring to FIG. 4, the remote wireless charging system can be implemented in a vehicle 40. The remote wireless charging device 10′ is connected to a lighter plug 41 in the car and connected to the vehicle's battery 42, which serves as the power source of the wireless charging device 10′ to charge three mobile devices 43, 44 and 45, which have receivers 43′ 44′ 45′ respectively. The remote wireless charging device 10′ can transmit power through wireless broadcasting to all those three mobile devices (43, 44, 45) within the space, so all three devices are being charged without any physical connection or contact with the wireless charger 10′ and regardless of the orientation between the wireless charger 10′ and the mobile devices (43, 44, 45).

As shown in FIG. 3 and a block diagram in FIG. 6, the wireless charging transmitter 300 is configured to receive the input energy from the power source 400 and generates the radiated energy field 30, which is sent out through the wireless charging antenna 200. The receiver 22 of the mobile device 20, separated from the transmitter 300 within a predetermined distance D, is configured to receive and generate an output power to power the mobile device 20 and the output power can be stored in a rechargeable battery 24.

The power control circuit 500 may include a power managing unit 510 that is configured to manage the usage of the power source 400. More particularly, the power managing unit 510 is configured to detect a minimum charging voltage of the mobile device 20 through a detecting unit 530 and communicatively work with the detecting unit 530 to continuously monitor the charging status of a rechargeable battery 24 in the mobile device 20 and the power source 400. When the detecting unit 530 concludes that the mobile device 20 has been fully charged, the remote wireless charging process would be terminated within a few seconds to save the battery power.

Temperature is an important factor for battery life and efficiency. High temperature may adversely affect the battery life and efficiency. In a further embodiment shown in FIG. 6, the power control circuit 500 may also include a temperature control unit 520 to control and reduce the heat emission while the wireless charging device 10 is functioning to increase the battery life and efficiency.

Comparing with conventional remote wireless charging, the present invention is advantageous because (i) the remote wireless charging device 10 is omnidirectional, compact, lightweight, and has a high capacity battery; (ii) with the fuel cell 410, the remote wireless charging device 10 has significantly larger capacity for electrical energy; (iii) the remote wireless charging device 10 has a controller modulus including a power control circuit 500 and a wireless charging transmitter 300, to significantly increase the charging speed comparing with regular USB cable charging and traditional wireless charging; and (iv) simultaneously charge multiple devices and increase the distance of between the wireless charging device 10 and the devices through a wireless antenna 200 with a predetermined frequency and shape.

Having described the invention by the description and illustrations above, it should be understood that these are exemplary of the invention and are not to be considered as limiting. Accordingly, the invention is not to be considered as limited by the foregoing description, but includes any equivalents.

What is claimed is:

1. A remote wireless charging apparatus comprising:
a power source to provide an input energy;
a wireless charging transmitter configured to receive said input energy from the power source and send the input energy to a wireless charging antenna;
a wireless charging antenna configured to receive and emit the energy received from the wireless charging transmitter to realize the wireless charging; and
a power control circuit to manage usage of the power source,
wherein a receiver of a mobile device is separated from the wireless charging transmitter within a predetermined distance, and configured to receive the energy emitted from the wireless charging antenna, and the wireless charging transmitter and the receiver are configured to reach a mutual resonant frequency to minimized energy loss and increase the predetermined distance between the mobile device and the wireless charging transmitter.

2. The remote wireless charging apparatus of claim 1, wherein a shape of the wireless charging antenna, and the frequency of the wireless charging transmitter and the receiver are adjustable to enable energy transmission between the mobile device and remote wireless charging apparatus even though the mobile device and the remote wireless charging apparatus are not well-aligned.

3. The remote wireless charging apparatus of claim 1, wherein the power control circuit further includes a temperature control unit to control and reduce the heat emission while the mobile device is remotely and wirelessly charged.

4. The remote wireless charging apparatus of claim 1, wherein one or more mobile devices are allowed to be simultaneously charged within a predetermined distance by the remote wireless charging apparatus.

5. The remote wireless charging apparatus of claim 1, wherein the wireless charging transmitter is configured to detect the existence of a non-aligned signal from an external receiving device, and if the non-aligned signal is detected, the wireless charging transmitter sends out a signal to the power control circuit not to initiate the wireless charging process.

6. The remote wireless charging apparatus of claim 1, wherein the power source includes a refillable fuel cell and a battery.

7. The remote wireless charging apparatus of claim 6, wherein the refillable fuel cell is a direct methanol fuel cell (DMFC).

8. A remote wireless charging system comprising:
a wireless charging apparatus comprising a power source to provide an input energy; a wireless charging transmitter configured to receive said input energy from the power source and send the input energy to a wireless charging antenna; a wireless charging antenna configured to receive and emit the energy received from the wireless charging transmitter to realize the wireless charging; and a power control circuit to manage usage of the power source; and
a mobile device including a receiver and a rechargeable battery,
wherein the receiver of the mobile device is separated from the wireless charging transmitter within a predetermined distance, and configured to receive the energy emitted from the wireless charging antenna, and the wireless charging transmitter and the receiver are configured to reach a mutual resonant frequency to minimized energy loss and increase the predetermined distance between the mobile device and the wireless charging transmitter.

9. The remote wireless charging system of claim 8, wherein a shape of the wireless charging antenna, and the frequency of the wireless charging transmitter and the receiver are adjustable to enable energy transmission between the mobile device and remote wireless charging apparatus even though the mobile device and the remote wireless charging apparatus are not well-aligned.

10. The remote wireless charging system of claim 9, wherein the power control circuit further includes a temperature control unit to control and reduce the heat emission while the mobile device is remotely and wirelessly charged.

11. The remote wireless charging system of claim 8, wherein one or more mobile devices are allowed to be simultaneously charged within a predetermined distance by the wireless charging apparatus.

12. The remote wireless charging system of claim 8, wherein the wireless charging transmitter is configured to detect the existence of a non-aligned signal from an external receiving device, and if the non-aligned signal is detected, the wireless charging transmitter sends out a signal to the power control circuit not to initiate the wireless charging process.

13. The remote wireless charging system of claim 8, wherein the power source of said wireless charging apparatus includes a refillable fuel cell and a battery.

14. The remote wireless charging system of claim 13, wherein the refillable fuel cell is a direct methanol fuel cell (DMFC).
